(19) United States
(12) Patent Application Publication
(10) Pub. No.: US 2012/0115361 A1
(43) Pub. Date: May 10, 2012

(54) ELECTRONIC CONNECTOR MODULE

(75) Inventors: Ti-Ming Hsu, Taipei City (TW); Chieh-Tian Chen, Taipei City (TW); Szu-Chi Lee, Taipei City (TW)

(73) Assignee: COMPAL ELECTRONICS, INC., Taipei City (TW)

(21) Appl. No.: 13/291,044

(22) Filed: Nov. 7, 2011

Related U.S. Application Data
(60) Provisional application No. 61/411,457, filed on Nov. 8, 2010.

(51) Int. Cl. H01R 13/648

(52) U.S. Cl. 439/607.01

(57) ABSTRACT

An electronic connector module suitable for being mounted at a motherboard is provided. The electronic connector module includes a connector for selectively coupling an ESD protection component. When the connector receives an static electricity, the connector is grounded through the motherboard via the ESD protection component.

### CROSS-REFERENCE TO RELATED APPLICATION

This application claims the priority benefits of U.S. provisional application Ser. No. 61/411,457, filed on Nov. 8, 2010. The entirety of the above-mentioned patent application is hereby incorporated by reference herein and made a part of this specification.

### BACKGROUND OF THE INVENTION

1. Field of the Invention

The invention generally relates to an electronic connector, and more particularly, to an electronic connector module with electrostatic discharge (ESD) component.

2. Description of Related Art

For accessing wired Internet, most types of PC are equipped with a port of local area network (LAN) so as to connect a local network cable. The most common LAN port nowadays is an RJ45 female connector (RJ45 is referred to as a registered jack connector standard), which can be connected to a corresponding RJ45 male connector disposed at the end of a network cable by plugging the male one into the female one.

In an environment where lightning may occur, the external high-voltage current may be transferred into the PC via the RJ45 female connector, so that four pairs of differential signal wires belonging to LAN in the motherboard of the PC must keep a certain distance from the ground and from other signal wires to prevent the high-voltage current on the LAN signal wires from jumping to the ground or other signal wires of the motherboard. The testing to achieve the above-mentioned object is called as Hi-POT testing.

In addition, in a dry environment where static electricity is likely produced, the external static charges may be transferred into the PC via the RJ45 female connector, so that every signal wire belonging to the LAN in the motherboard needs to be grounded through electrostatic discharge (ESD) diode, which enables static charges on any LAN signal wire flowing to the ground via the ESD diode through the shortest path. The testing to achieve the above-mentioned object is called as ESD testing.

According to the requirement of Hi-POT testing, the distance between the LAN signal wires and the ground is designed by taking the maximum impedance as object; on the contrary, according to the requirement of ESD testing, the distance between the LAN signal wires and the ground is designed by taking the minimum impedance as object. However, it is impossible for a single PC to simultaneously satisfy the requirements of both Hi-POT testing and ESD testing.

A PC must pass Hi-POT testing or ESD testing to follow the local law/regulations of market. If the manufacturer is forced by the above-mentioned requirements to design and produce two motherboards respectively passing Hi-POT testing and ESD testing for a same PC, the manufacturer must pay higher cost.

### SUMMARY OF THE INVENTION

Accordingly, the invention is directed to an electronic connector module for selectively providing ESD protection function.

The invention discloses an electronic connector module. The electronic connector module includes a connector for selectively coupling an ESD protection component. When the connector receives a static electricity, the connector is grounded through the motherboard via the ESD protection component.

Based on the above description, the invention integrates an ESD protection component to an electronic connector and provides ESD protection function by selectively enabling the ESD protection component.

### BRIEF DESCRIPTION OF THE DRAWINGS

FIG. 1 is a schematic diagram of an electronic connector module according to an embodiment of the invention.

FIG. 2 is a block diagram showing the electronic connector module of FIG. 1 to a motherboard.

FIG. 3 is a schematic diagram of a switch component according to another embodiment of the invention.

FIG. 4 is a schematic diagram of a switch component according to yet another embodiment of the invention.

FIG. 5 is a schematic diagram of a switch component according to yet another embodiment of the invention.

FIG. 6 is a schematic diagram of an electronic connector module according to another embodiment of the invention.

FIG. 7 is a schematic diagram of the electronic connector module of FIG. 6 in plugging state.

### DESCRIPTION OF THE EMBODIMENTS

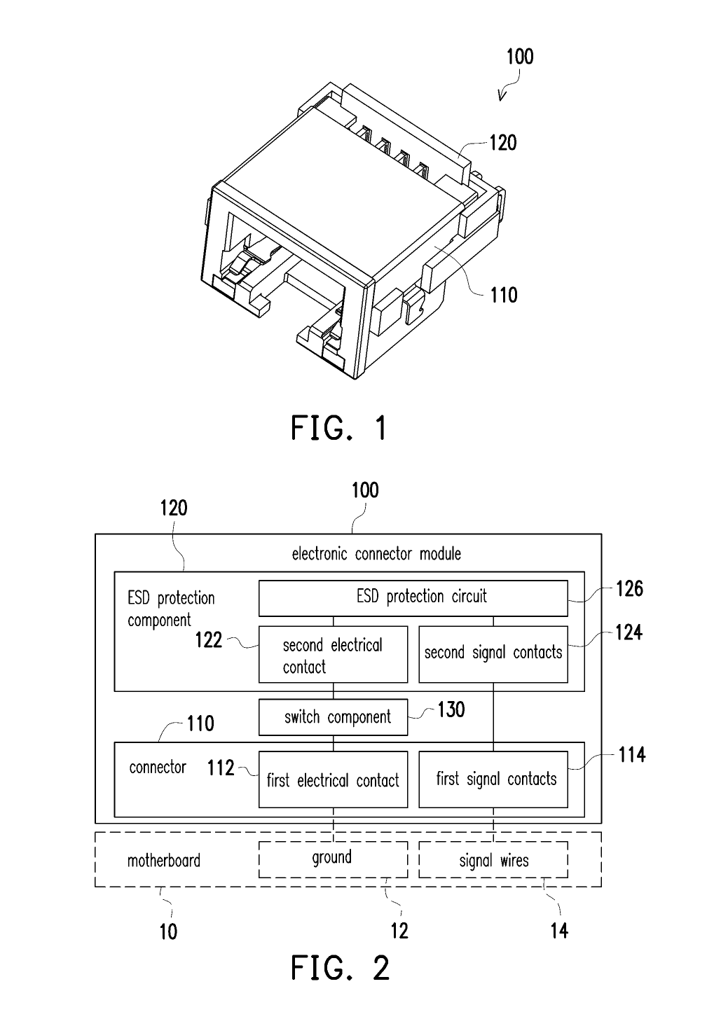

FIG. 1 is a schematic diagram of an electronic connector module according to an embodiment of the invention and FIG. 2 is a block diagram showing the electronic connector module of FIG. 1 to a motherboard. Referring to FIGS. 1 and 2, an electronic connector module 100 of the embodiment includes a connector 110 and an ESD protection component 120. The connector 110 has a first electrical contact 112. In the embodiment, the connector 110 can be an RJ45 female connector, but can be other electronic connectors as well. The ESD protection component 120 is disposed at the connector 110 and has a second electrical contact 122. In the embodiment, whether the connector 110 is selectively connected to the ESD protection component 120 is decided by coupling the second electrical contact 122 to the first electrical contact 112 or not, and thereby the ESD protection component 120 is enabled or not.

Referring to FIG. 2, the connector 110 can further have a plurality of first signal contacts 114 and the ESD protection component 120 can further have a plurality of second signal contacts 124. The second signal contacts 124 are respectively coupled to the first signal contacts 114. The ESD protection component 120 can further have an ESD protection circuit 126, which makes the second signal contacts 124 respectively coupled to the second electrical contact 122.

In the embodiment, the first electrical contact 112 of the connector 110 is coupled to a ground 12 of a motherboard 10, and the first signal contacts 114 of the connector 110 are respectively coupled to a plurality of signal wires 14 of the motherboard 10 of an electronic apparatus. In this way, when the external static electricity arrives at the first signal contacts 114, the static charges can be directly guided to the ground of the motherboard 10 via the ESD protection circuit 126 without flowing to the signal wires 14 of the motherboard 10.

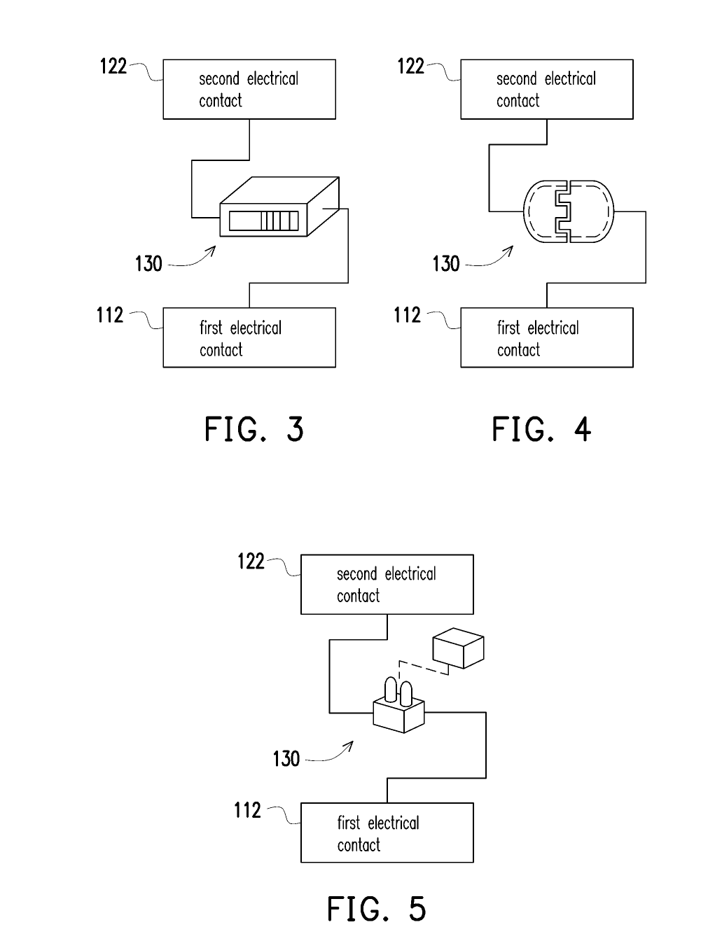

FIG. 3 is a schematic diagram of a switch component according to another embodiment of the invention. Referring to FIG. 3, in the embodiment, the switch component 130 can be a finger poking switch, so that whether the second electrical contact 122 is coupled to the first electrical contact 112 is decided by poking the switch component 130. In the embodiment, the switch component 130 can be disposed outside the connector 110 of FIG. 1 for user to poke.

FIG. 4 is a schematic diagram of a switch component according to yet another embodiment of the invention. Referring to FIG. 4, in the embodiment, the switch component 130 can include a pair of adjacent jumper pads, in which whether the second electrical contact 122 is coupled to the first electrical contact 112 is decided by soldering the pair of adjacent jumper pads with solder (marked with a hidden line) or not.

FIG. 5 is a schematic diagram of a switch component according to yet another embodiment of the invention. Referring to FIG. 5, in the embodiment, the switch component 130 can include a jumper connector, in which whether the second electrical contact 122 is coupled to the first electrical contact 112 is decided by connecting another corresponding jumper connector to the above-mentioned jumper connector or not.

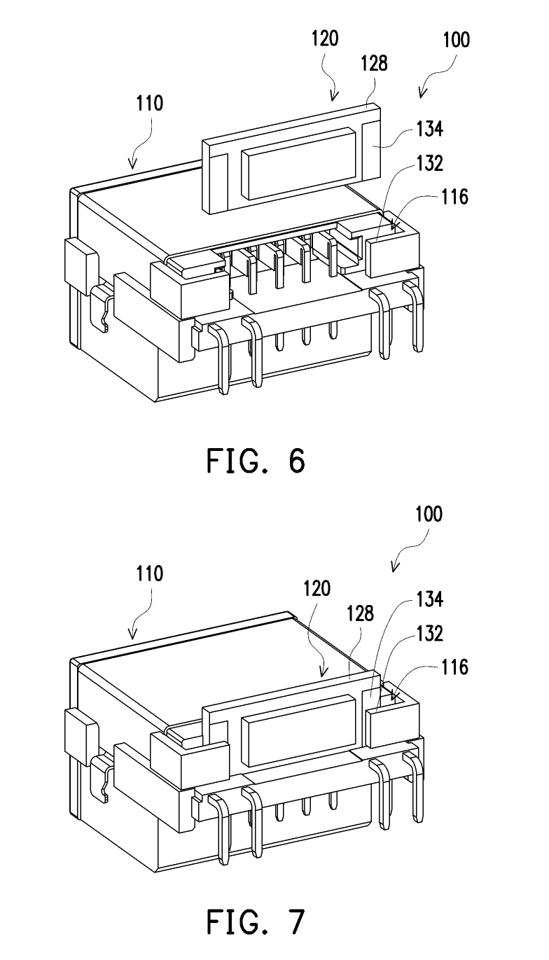

FIG. 6 is a schematic diagram of an electronic connector module according to another embodiment of the invention and FIG. 7 is a schematic diagram of the electronic connector module of FIG. 6 in plugging state. Referring to FIGS. 6 and 7, in the embodiment, the connector 110 can have a slot 116 and a lead 132, while the ESD protection component 120 can have a card 128 and a pad 134, in which whether the lead 132 contacts the pad 134 and further thereby whether the second electrical contact 122 is coupled to the first electrical contact 112 are decided by plugging the card 128 into the slot 116 or not. In the embodiment, the lead 132 can be formed by a portion of the connector 110, while the pad 134 can be formed by a portion of the ESD protection component 120.

In summary, in the invention, the ESD protection component is integrated to the electronic connector, and the invention can, according to practical need, provide ESD protection function by enabling the ESD protection component or not through controlling the ESD protection component. In this way, when the motherboard of an electronic apparatus has a circuit architecture conforming with Hi-POT testing standard in advance, the invention is able to switch the above-mentioned circuit architecture conforming with Hi-POT testing standard to a circuit architecture conforming with ESD testing standard so as to lower down the cost.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An electronic connector module, suitable to be mounted at a motherboard and comprising:
a connector, for selectively coupling an ESD protection component, wherein when the connector receives an static electricity, the connector is grounded through the motherboard via the ESD protection component.

2. The electronic connector module as claimed in claim 1, wherein the connector is an RJ45 female connector.

3. The electronic connector module as claimed in claim 1, wherein the connector has a plurality of first signal contacts, the ESD protection component has a plurality of second signal contacts and an ESD protection circuit, the second signal contacts are respectively coupled to the first signal contacts, and the second signal contacts are respectively coupled to the ESD protection circuit.

4. The electronic connector module as claimed in claim 1, further comprising:
a finger poking switch, for deciding whether the ESD protection component is coupled to the connector by poking the finger poking switch.

5. The electronic connector module as claimed in claim 1, further comprising:
a pair of adjacent jumper pads, for deciding whether the ESD protection component is coupled to the connector by soldering the pair of adjacent jumper pads with solder or not.

6. The electronic connector module as claimed in claim 1, further comprising:
a jumper connector, for deciding whether the ESD protection component is coupled to the connector by connecting another jumper connector to the above-mentioned jumper connector or not.

7. The electronic connector module as claimed in claim 1, wherein the connector has a slot and a lead, and the ESD protection component has a card and a pad for deciding whether the ESD protection component is coupled to the connector by plugging the card into the slot or not.
